(19) United States
(12) Patent Application Publication
(10) Pub. No.: US 2025/0100512 A1
(43) Pub. Date: Mar. 27, 2025

(54) WINDOW CLEANING ROBOT

(71) Applicant: SHENZHEN ONEJ TECHNOLOGY CO., LTD, Shenzhen (CN)

(72) Inventors: LI-GUO DING, Shenzhen (CN); YAN JUN KE, Shenzhen (CN)

(73) Assignee: SHENZHEN ONEJ TECHNOLOGY CO., LTD, Shenzhen (CN)

(21) Appl. No.: 18/892,189

(22) Filed: Sep. 20, 2024

(30) Foreign Application Priority Data
Sep. 21, 2023 (CN) 202322595393.2

(51) Int. Cl. B60S 1/38; B60S 1/42

(52) U.S. Cl. CPC B60S 1/3801; B60S 1/42

(57) ABSTRACT

A window cleaning robot includes a main body having a base assembly, a housing and a plurality of elastic wiper modules. The elastic wiper module includes an elastic component and a wiper, wherein a first end of the elastic component is coupled to the base assembly and at least one second end is coupled to the wiper. The first end is opposite to the second end and the wiper is leaned against window glass under acting force of the elastic component.

### FIELD

The subject matter herein generally relates to a window cleaning robot, especially a window cleaning robot having wipers.

### BACKGROUND

The wiper is a component installed in the window cleaning robot and used to adhere to the glass plane to scrape off waterdrops. The current wiper of the window cleaning robot is directly mounted on a cleaning cloth or a floating plate of the window cleaning robot. Therefore, the current wiper has movements accompany with the movements of the cleaning cloth or the floating plate. In the meant time, the current wiper moves up and down and is not leaned against the window glass all the time when the window cleaning robot performs the window cleaning work. Moreover, the current wiper cannot be constantly leaned against the window glass due to changes of the thickness of the cleaning component or deformation of the floating plate is happened.

### SUMMARY

The purpose of the present disclosure is to provide a window cleaning robot.

To achieve the above purpose, the current disclosure discloses a window cleaning robot. The window cleaning robot includes a main body having a base assembly, a housing and a plurality of elastic wiper modules. The elastic wiper module includes an elastic component and a wiper, wherein a first end of the elastic component is coupled to the base assembly and at least one second end is coupled to the wiper. The first end is opposite to the second end and the wiper is leaned against window glass under acting force of the elastic component.

It should be understood that the description in the section is not intended to identify key or important features of embodiments of the present disclosure, nor is it intended to limit the scope of the present disclosure. Other features of the present disclosure will be readily understood from the following specification.

### BRIEF DESCRIPTION OF THE DRAWINGS

In the accompanying drawings, unless otherwise specified, the same reference numerals throughout multiple accompanying drawings indicate the same or similar parts or elements. These accompanying drawings are not necessarily drawn to scale. It should be understood that these accompanying drawings depict only some embodiments disclosed in accordance with the present disclosure and should not be considered as limiting the scope of the present disclosure.

FIG. 1 is a schematic view of a window cleaning robot of one embodiment of the present disclosure;

FIG. 2 is an enlarged view of A of FIG. 1;

FIG. 3 is a cross-sectional view alone line B-B of FIG. 1;

FIG. 4 is a schematic view of a window cleaning robot of one embodiment of the present disclosure; and

FIG. 5 is an enlarged view of B of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasable connected.

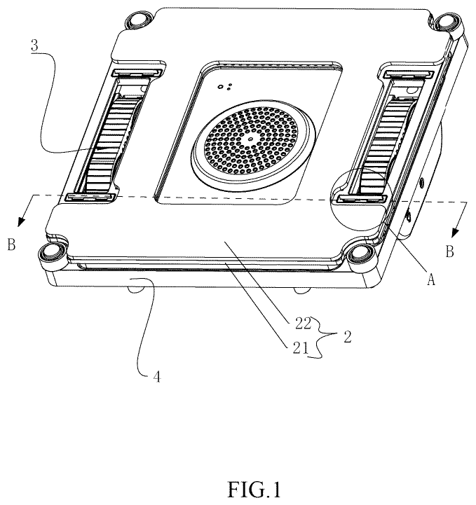

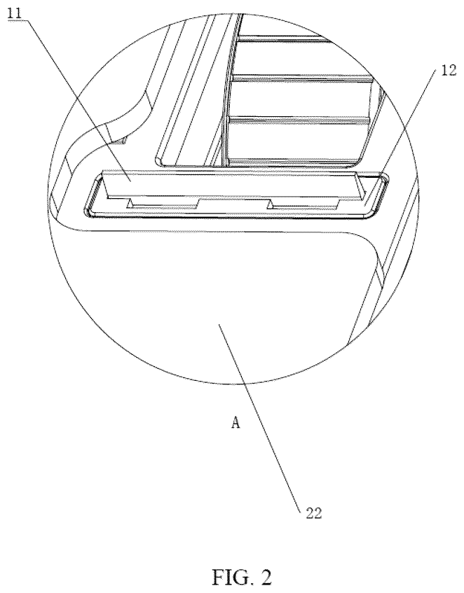

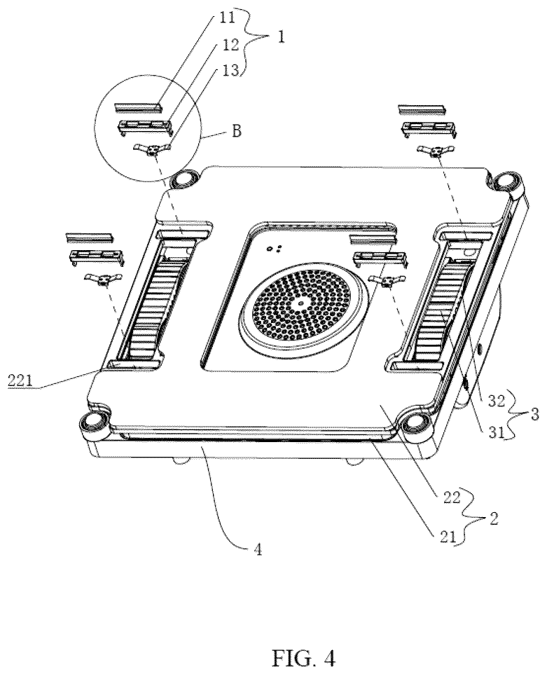

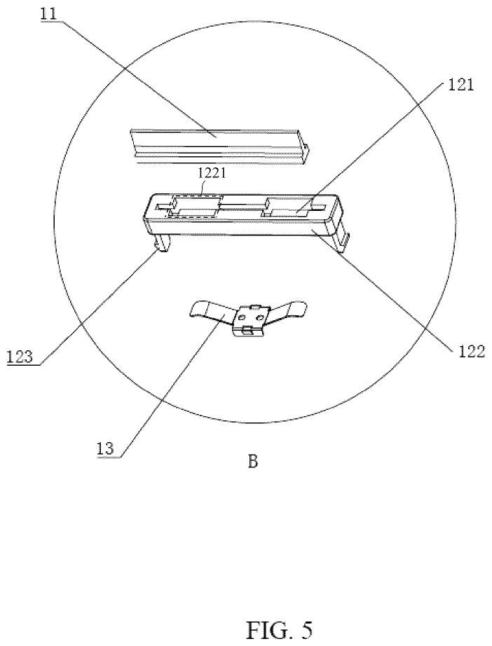

As shown in FIGS. 1 to 5, a window cleaning robot includes a main body 4. The main body 4 includes a base assembly 2 and a housing (not shown). The base assembly 2 includes a floating plate 21 and a cleaning component 22. In this embodiment, the cleaning component 22 is a fabric. The cleaning component 22 is detachably connected to the floating plate 21 and the cleaning component 22 is configured to wipe window glass. A plurality of elastic wiper modules 1 are disposed on the floating plate 21.

In this embodiment, the elastic wiper module 1 includes an elastic component 13 and a wiper 11. Moreover, a first end of the elastic component 13 is coupled to the base assembly 2 and at least one second end is coupled to the wiper 11. The first end is opposite to the second end. The wiper 11 is leaned against the window glass under acting force of the elastic component 13.

Since the elastic wiper module 1 is capable of floating against the window glass, the elastic wiper module 1 is constantly leaned against the window glass whether changes of the thickness of the cleaning component 22 or deformation of the floating plate 21 is happened. In this embodiment, the wiper 11 is made of elastic material, e.g. rubber or silica gel. Therefore, the wiper 11 is then leaned against the window glass and has vertical movements relevant to the window glass.

In this embodiment, the elastic wiper module 1 further includes a mounting bracket 12. The mounting bracket 12 includes an accommodating cavity 121 and the wiper 11 is installed in the accommodating cavity 121. Moreover, in this embodiment, the floating plate 21 of the base assembly 2 further includes a plurality of accommodating grooves 221 and each of the accommodating grooves 221 is configured to accommodate the elastic wiper module 1. In this embodiment, with the accommodating groove 221, the elastic wiper module 1 will not escape from the accommodating groove 221 when the elastic wiper module 1 wipes water drops on the window glass.

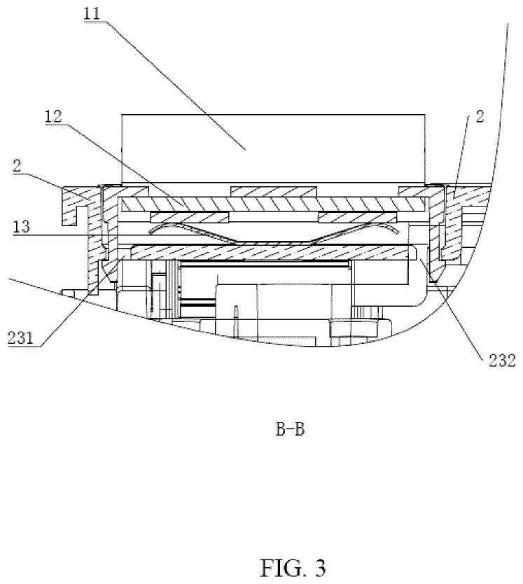

As shown in FIG. 3, the mounting bracket 12 includes a limit block 122 and at least two positioning arms 123. The positioning arm 123 is respectively located at each of two ends of the limit block 122. The positioning arms 123 respectively goes through a first opening 231 and a second opening 232 of the accommodating groove 221 to snap-connect to the base assembly 2. Moreover, the mounting bracket 12 and accommodating groove 221 define a space which allow actions of the elastic component 13 in the space. The mounting bracket 12 is detachably accommodated in the accommodating groove 221.

In this embodiment, the elastic component 13 includes a flat spring. The flat spring is pressed against wall of the accommodating groove 221 and held in the accommodating groove 221.

Moreover, in this embodiment, the accommodating cavity 121 includes a plurality of ventilation holes 1221 penetrating the accommodation cavity 121. The ventilation hole 1221 is configured to avoid water accumulated in the accommodation cavity 121 when the wiper 11 wipes water drops on the window glass.

In this embodiment, the base assembly 2 further includes at least two caterpillar mechanisms 3. The elastic wiper module 1 is vertically installed and is toward the moving path of the window cleaning robot. The elastic wiper module 1 is configured to scrap off water drops on the window glass for reducing chance of slipping of the caterpillar mechanism 3.

Furthermore, the caterpillar mechanism 3 includes driving mechanism 32 and continuous tracks 31 engaged with the driving mechanism 32. The window cleaning robot includes a motor for driving the driving mechanism 32 and the continuous tracks 31 is then driven. Therefore, the window cleaning robot is capable of moving on the window glass.

In this embodiment, the two caterpillar mechanisms 3 are respectively disposed in parallel at two sides of the base assembly 2 and each of the caterpillar mechanism 3 includes continuous tracks 31 and wherein the elastic wiper modules 1 are respectively disposed at two sides of the continuous tracks 31.

The following is a working example of the window cleaning robot. When the window cleaning robot is activated, the motor of the window cleaning robot drives the driving mechanism 32 and the continuous tracks 31 is then driven. The window cleaning robot starts moving on the window glass. At the meantime, the window cleaning robot spray water and the water drops on the window glass. With movements of the window cleaning robot, the cleaning component 22 is capable of removing particles on the window glass and the wiper 11 is also capable of scrapping off water drops on the window class.

The embodiments shown and described above are only examples and do not limit the patent scope of the disclosure. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A window cleaning robot, comprising:
a main body including a base assembly; and
a plurality of elastic wiper modules disposed on the base assembly, wherein the elastic wiper module includes an elastic component and a wiper;
wherein a first end of the elastic component is coupled to the base assembly and at least one second end is coupled to the wiper, wherein the first end is opposite to the second end and the wiper is leaned against window glass under acting force of the elastic component.

2. The window cleaning robot of claim 1, wherein the base assembly includes a floating plate and a cleaning component, wherein the elastic wiper module is elastically coupled to the floating plate and the cleaning component is for cleaning the window glass.

3. The window cleaning robot of claim 1, wherein the wiper is made of elastic material.

4. The window cleaning robot of claim 1, wherein the elastic wiper module further includes a mounting bracket, wherein the mounting bracket includes an accommodating cavity and the wiper is installed in the accommodating cavity.

5. The window cleaning robot of claim 1, wherein the base assembly further includes a plurality of accommodating grooves and each of the accommodating grooves is configured to accommodate the elastic wiper module.

6. The window cleaning robot of claim 1, wherein the elastic wiper module further includes a mounting bracket and the base assembly further includes a plurality of accommodating grooves and each of the accommodating grooves is configured to accommodate the elastic wiper module, wherein the mounting bracket includes at least two positioning arms and a limit block, wherein the positioning arms is respectively located at each of two ends of the limit block and the positioning arms respectively goes through a first opening and a second opening of the accommodating groove to snap-connect to the base assembly.

7. The window cleaning robot of claim 1, wherein the base assembly further includes a plurality of accommodating grooves and the elastic component includes a flat spring, wherein the flat spring is pressed against wall of the accommodating groove and held in the accommodating groove.

8. The window cleaning robot of claim 4, wherein the accommodating cavity includes a plurality of ventilation holes penetrating the accommodation cavity.

9. The window cleaning robot of claim 1, wherein the base assembly further includes at least two caterpillar mechanisms and the elastic wiper modules is configured to scrap off water drops.

10. The window cleaning robot of claim 9, wherein the two caterpillar mechanisms are respectively disposed in parallel at two sides of the base assembly and each of the caterpillar mechanism includes continuous tracks and wherein the elastic wiper modules are respectively disposed at two sides of the continuous tracks.
